(19) United States
(12) Patent Application Publication
(10) Pub. No.: US 2018/0238309 A1
(43) Pub. Date: Aug. 23, 2018

(54) CRANE BASKET

(71) Applicant: PP Energy ApS, Nordborg (DK)

(72) Inventors: Jesper Vildsø Flindt, Odense SV (DK); Mikkel Qvist Nielsen, Odense SV (DK); Johan Thrane Poulsen, Randers SØ (DK); Paul Teichert, Sydals (DK)

(21) Appl. No.: 15/554,765

(22) PCT Filed: Feb. 9, 2016
(86) PCT No.: PCT/DK2016/050036

§ 371 Date: Aug. 31, 2017

(30) Foreign Application Priority Data
Mar. 5, 2015 (DK) PA 2015 00137

(51) Int. Cl. F03D 80/55; B66F 11/04

(52) U.S. Cl. CPC F03D 80/55; B66F 11/04; F05B 2240/916; F05B 2230/80; F05B 2280/102; F05B 2280/1071; F05B 2280/6003; F05B 2250/11

(57) ABSTRACT

A device (1) for enabling access to a rotor blade (2) of a wind turbine is described, said device (1) comprising a frame (3) having connecting means (4) located at an upper region of said frame (3) and being structured in the range to be connected to a hoisting device. Such a device should be of simple construction, which is easy to control. To this end said frame (3) is in form of a triangle, said connecting means (4) being located in a region of an edge of said triangle.

### CROSS-REFERENCE TO RELATED APPLICATIONS

This application is a National Stage application of International Patent Application No. PCT/DK2016/050036, filed on Feb. 9, 2016, which claims priority to Danish Patent Application No. PA 2015 00137, filed on Mar. 5, 2015, each of which is hereby incorporated by reference in its entirety.

### TECHNICAL FIELD

The present invention relates to a device for enabling access to a rotor blade of a wind turbine, said device comprising a frame having connecting means located in an upper region of said frame and being structured and arranged to be connected to a hoisting device.

### BACKGROUND

Such a device is known, for example, from EP 2 315 938 B1.

Such a device is used to transport persons to the blade of a wind mill in order to perform service at this rotor blade. This service includes among others inspection, repair, and cleaning of the blade.

A blade of a wind turbine is in many cases inclined with respect to the direction of gravity. This is considered to be necessary to avoid a contact between the blade and the tower of the wind turbine during operation. Furthermore, the blade is in many cases slightly curved. This makes it difficult to move the device along the blade so that a person on a platform connected to the frame can reach the complete surface of the blade.

In most cases complicated control mechanisms are necessary to control the movement of the device which is furthermore of heavy weight.

### SUMMARY

The object underlying the invention is to provide for a device of simple construction which is easy to control during movement.

This object is solved with a device as described at the outset in that said frame is in form of a triangle, said connecting means being located in a region of an edge of said triangle.

During operation the hoisting device is connected to the connecting means so that the frame can be lifted together with all parts connected to the frame. A simple form of a triangle is sufficient to accommodate all parts necessary for service of the blade including means for guiding the frame along the blade. Since these means do not have to carry heavy loads but are used only for position the frame with respect to the blade, they can be made with low weight and simple construction.

Preferably said triangle is oriented vertically with respect to a direction of gravity. This orientation is not meant in a mathematical limited sense. The triangle is oriented upright. During operation the triangle can be tilted by a small angle in order to follow the contour of the blade. However, the orientation is basically vertical or upright. This means that the main supporting structure for the device is arranged in a basically upright or vertically orientated plane.

Preferably said triangle comprises two shanks, each shank carrying a platform. It is not necessary that the triangle is massive. Basically it is sufficient when the triangle is made of a number of rods which are connected to each other. The connection of rods in the form of a triangle has a result that such a frame is practically undeformable. This gives a high stability with low weight. Since the two shanks run away from each other starting from a point near the connecting means there is enough space to accommodate two platforms so that two persons can perform service at the blade at the same time, i.e. both sides of the blade are accessible at the same time.

Preferably each platform forms a base of a basket. Such a basket protects the service people from falling down. This is an important factor since the device is usually used in a considerable height.

Preferably said baskets have access means, said access means facing each other. Such access means can be formed, for example, by a door. When the access means face each other, the access means of one basket is accessible from the other basket. This can be used in emergency cases to allow the evacuation of one basket to the other basket.

Preferably said platform is moveable in a direction parallel to said triangle. In other words, the platform can be adjusted in vertical or upright direction. This gives more possibilities for the service people to reach the complete area of the blade.

Additionally or alternatively it can be advantageous that said platform is moveable in a direction perpendicular to said triangle. This possibility as well enables the service people to reach the whole area of the blade.

Preferably said connecting means form a single point of connection to said hoisting device. This means that a simple crane which can be positioned in the nacelle of the wind turbine is sufficient to control the movement of the device along the blade. No complicated control with a plurality of robes is necessary. In any case, safety robes can still be used.

Preferably said frame comprises at least two sets of rollers in different heights with respect to the direction of gravity. These two or more sets of rollers can be used to support the device against an edge of the blade during the movement of the device along the blade. When at least two sets of rollers are used, the orientation of the device with respect to the blade can be adjusted to follow the form of the front or rear edge of the blade.

Preferably said rollers are offset relative to each other in a direction perpendicular to said direction of gravity. This takes into account that the blade is usually not orientated exactly in direction of gravity but inclined to this direction. This implication can at least partly be neutralized by the offset of the sets of rollers.

Preferably said rollers are adjustable perpendicular to said direction of gravity. The device can be adapted to different blades.

Furthermore, it is preferred that said frame carries contact means having a greater distance to said frame than said rollers. These contact means support the device laterally with respect to the blade. The greater distance means a longer lever so that there is a greater resistance against rotational movements of the device around the blade.

Preferably said contact means are in form of brushes. A brush may transfer load to the rotor blade at a sufficiently large area, thereby reducing the load per area. Furthermore, a brush has the advantage that it may be moved across the surface of the blade in any direction, i.e. omnidirectionally.

In a preferred embodiment said rollers and/or said contact means are located in a position higher than said platforms in direction of gravity. In other words, the rollers and contact means are placed above the platforms. When the device is at the beginning of the service lowered down to the lower tip of the blade and work will start when hoisting up, the rollers and/or contact means will not cross the working area after work has been performed.

Preferably said frame is made of a fiber reinforced plastic material, of a light metal or of a stainless steel. The fiber reinforced plastic material can be glass fiber reinforced plastic, for example with thermosetting plastic like polyester, epoxy, etc. or with thermoplastics, like polyamide, PVC or the like. Furthermore, carbon fiber reinforced plastics can be used with the same plastic material. Another possibility is the use of aramid or para-aramid fiber reinforced plastics, e.g. Kevlar. Another possibility is the use of light metal like aluminum, titanium or high strength steel. Furthermore, stainless steel materials may be used, e.g. austenitic stainless, like W.nr.1.4301 and 1.4401, duplex stainless, like W.nr.1.4462 or super duplex stainless, like W.nr.1.4410. The use of such material safes weight so that the whole device can be lifted and operated with smaller forces.

### BRIEF DESCRIPTION OF THE DRAWINGS

An embodiment of the present invention will now be described in more detail with reference to the drawing, in which:

FIG. 1 shows a front view of a device,

FIG. 2 shows a perspective view of the device,

FIG. 3 shows a side view of the device and

FIG. 4 shows some positions of the movement of the device along a blade.

### DETAILED DESCRIPTION

A device 1 for enabling access to a rotor blade 2 of a wind turbine comprises a frame 3. The frame 3 has connecting means 4 to be connected to a hoisting device 5 in form of a robe made of steel wires. The connecting means 4 form a single point of connection.

The frame 3 is in form of a triangle or in form of the letter “A”. This frame is orientated vertically with respect to a direction of gravity. The connecting means 4 are located at the upper end of the triangle.

The frame 3 comprises two shanks 6, 7. Each shank 6, 7 carries a platform 8, 9. Each platform 8, 9 forms a basis for a basket 10, 11.

Each basket 10, 11 has access means 12, 13 in form of a removable bar or in form of a door. The access means 12, 13 of the two baskets 10, 11 face each other so that in emergency cases a person 14 in basket 10 can be rescued via the other basket 11 or a person 15 in the other basket 11 can be rescued via the first basket 10.

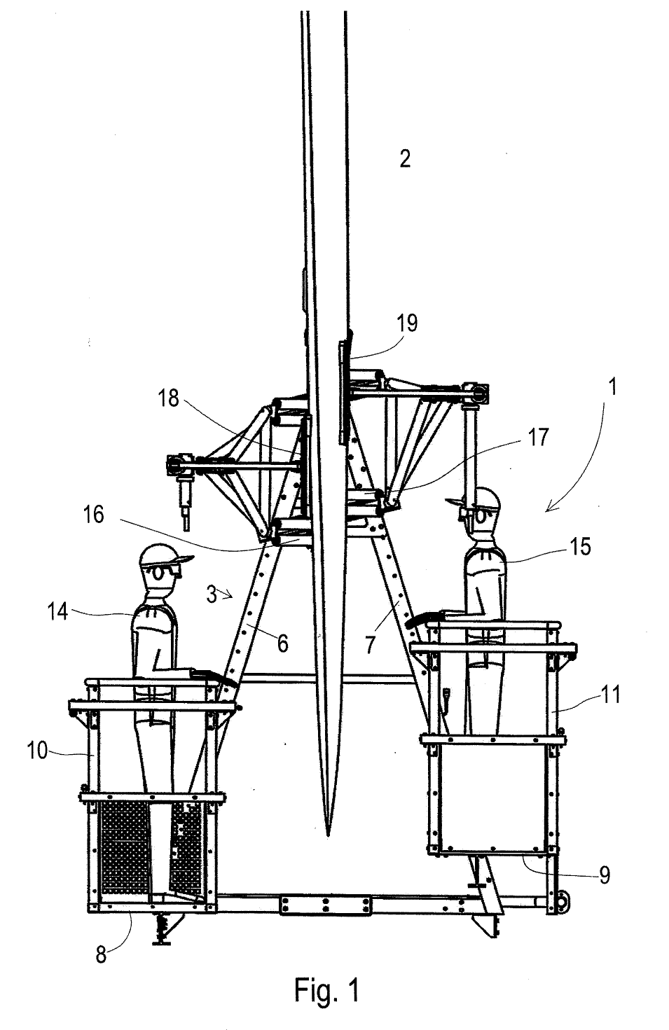

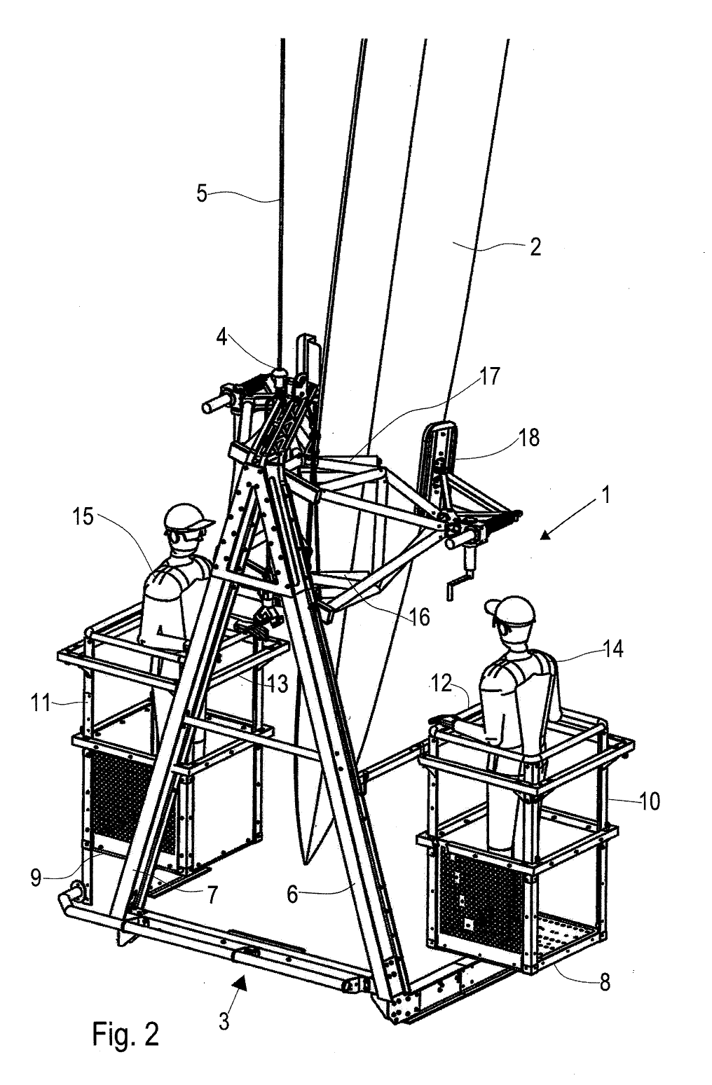

As can be seen in particular in FIGS. 1 and 2, the platforms 8, 9 are moveable with respect to the frame 3 in vertical direction, i.e. basically parallel to the triangular form of the frame 3. In this way it is possible to adjust the position of each platform 8, 9 in different height which makes it easier for the person 14, 15 in each basket 10, 11 to reach all areas of the blade 2.

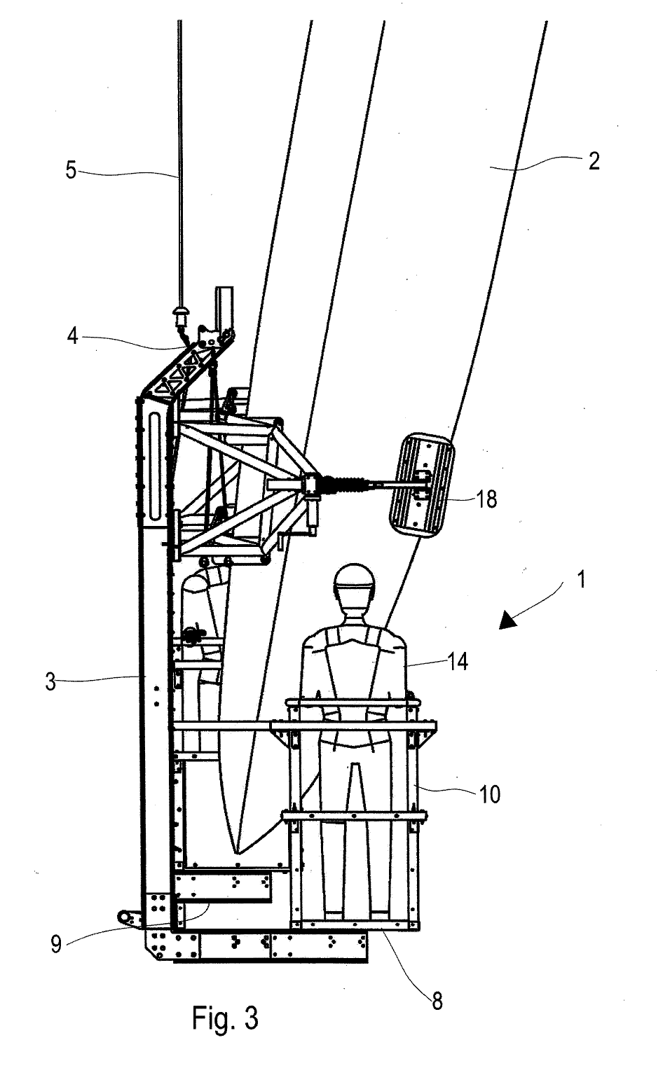

Furthermore, as can be seen in particular in FIGS. 2 and 3, the platforms 8, 9 can be moved in a direction perpendicular to the frame 3, i.e. to the triangle. This again is a possibility for the person 14, 15 to reach the whole of the surface of the blade 2 in a simple way.

Drives or actuators controlling the movements of the platforms 8, 9 with respect to the frame 3 are not shown for sake of clarity.

The frame 3, the platforms 8, 9 and the baskets 10, 11 can be made of a light weight material, for example reinforced plastic material, light metal or stainless steel.

The fiber reinforced plastic material can be in form of glass fiber reinforced plastic, like thermosetting plastics, e.g. polyester, epoxy or with thermoplastics, e.g. polyimide, PVC.

Alternatively a fiber reinforced plastic material can be reinforced by carbon fiber wherein the same plastic materials can be used. Furthermore, aramid or para-aramid fiber can be used for reinforcement, e.g. Kevlar.

The light metals can be for example aluminum or titanium.

Furthermore, it is possible to use high strength steel or stainless steel, like austenitic stainless, e.g. W.nr.1.4301 and 1.4401, duplex stainless, e.g. W.nr.1.4462, or super duplex stainless, e.g. W.nr.1.4410.

The use of such light weight material makes the whole construction light weight which has several advantages. One advantage is that only a single point of connection to the hoisting device 5 and a single hoisting device 5 are necessary. The forces for lifting the device are smaller so that a crane which is installed on the nacelle of the wind turbine, for example, can be dimensioned with less power.

As can be seen in particular in FIGS. 1, 2 and 4 device 1 comprises two sets of rollers 16, 17 which are located at the frame 3 in different heights with respect to the direction of gravity. The direction of gravity can be used to describe the location of the sets of rollers 16, 17 in this case, because the device 1 has a clear defined orientation during operation and use.

The two sets of rollers 16, 17 are offset relative to each other in a direction perpendicular to said direction of gravity, i.e. perpendicular in a direction perpendicular to the orientation of the frame 3. The offset can be small. The offset can be chosen, for example, so that a straight line through the middle axis of the rollers 16, 17 includes an angle of approximately 4° with a longitudinal axis of the frame 3.

Furthermore, the frame 3 carries contact means 18, 19 in form of brushes or the like. The contact means 18, 19 and the rollers 16, 17 are located in a position higher than said platforms 8, 9 in direction of gravity. When the service starts, the device is positioned at the lower tip of blade 2 and then moved upwardly. The rollers 16, 17 and the contact means 18, 19 will not cross the area of the blade after a service has been performed. This is in particular useful when the service includes repair of the surface of the blade which requires in some cases liquid plastics.

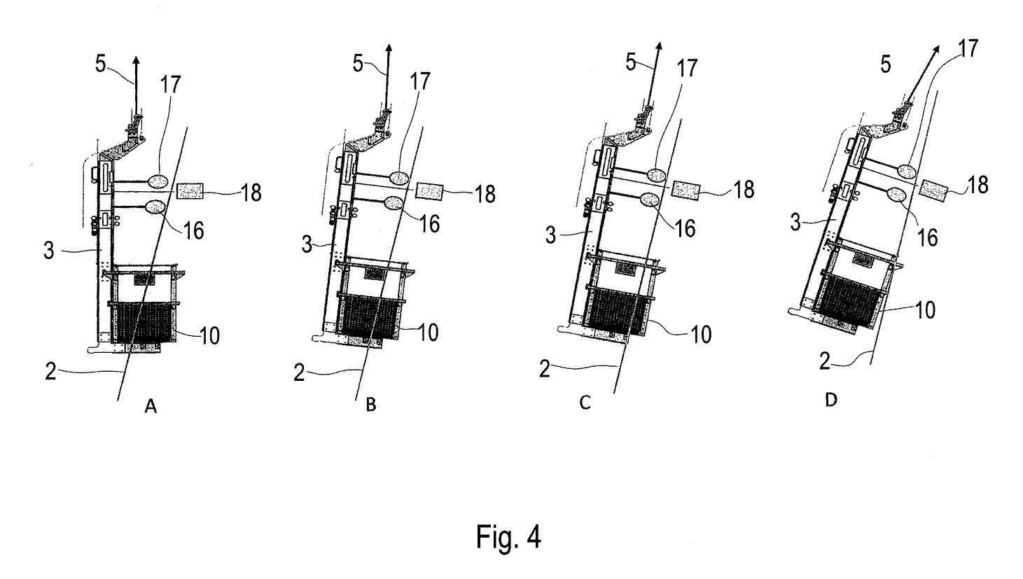

FIG. 4 shows some positions of the device 1. When the device 1 is lowered to the lower tip of the blade 2 in step A the first interaction with blade 2 is shown. Only the lower rollers 16 are in contact with the blade 2. The angle of the hoisting device 5 to the direction of gravity is 0° and the angle of the device 1, i.e. of frame 3 relative to a direction of gravity is 0° as well.

In position B the frame rotates from 0° to 2°, wherein the top rollers 17 come into contact with the blade 2 when the angle of the frame 3 is 2°. The hoisting device 5 will be in angle between 0° and 0.85°, for example.

In the position C both top and bottom rollers 16, 17 are in contact with the blade 2 and the frame 3 is in an angle of 2° relative to the direction of gravity. The device 1 is lowered and the angle of the hoisting device 5 will go from 0.85° to 4°, for example. The illustration in FIG. 4 shows the angle exaggerated for clarity.

When, as shown in position D, the angle of the hoisting device 5 exceeds 21°, for example, the lower rollers 16 will lift and there will only be contact with the top rollers 17.

In any case, the frame 3 still remains upright and the platforms 8, 9 will still remain basically in horizontal orientation so that there is no danger for the person 14, 15 in the baskets 10, 11.

The rollers 16, 17 and the contact means 18, 19 can be, if necessary, adjusted to adapt the device 1 to different forms of blades.

As can be seen, in particular in FIGS. 3 and 4, the contact means 18, 19 have a greater distance to frame 3 than the rollers 16, 17.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A device for enabling access to a rotor blade of a wind turbine, said device WA comprising a frame having connecting means located in an upper region of said frame and being structured and arranged to be connected to a hoisting device, wherein said frame is in form of a triangle, said connecting means being located in a region of an edge of said triangle.

2. The device according to claim 1, wherein said triangle is oriented vertically with respect to a direction of gravity.

3. The device according to claim 1, wherein said triangle comprises two shanks, each shank carrying a platform.

4. The device according to claim 3, wherein each platform forms a base of a basket.

5. The device according to claim 4, wherein said baskets have access means, said access means facing each other.

6. The device according to claim 3, wherein said platforms are movable in a direction parallel to said triangle.

7. The device according to claim 3, wherein said platforms are movable in a direction perpendicular to said triangle.

8. The device according to claim 1, wherein said connecting means form a single point of connection to said hoisting device.

9. The device according to claim 1, wherein said frame comprises at least two sets of rollers in different heights with respect to the direction of gravity.

10. The device according to claim 9, wherein said rollers are offset relative to each other in a direction perpendicular to said direction of gravity.

11. The device according to claim 9, wherein said rollers are adjustable in a direction perpendicular to said direction of gravity.

12. The device according to claim 8, wherein said frame carries contact means having a greater distance to said frame than said rollers.

13. The device according to claim 12, wherein said contact means are in form of brushes.

14. The device according to claim 12, wherein said rollers and/or said contact means are located in a position higher than said platforms in direction of gravity.

15. The device according to claim 1, wherein said frame is made of a fiber reinforced plastic material, of a light metal or of a stainless steel.

16. The device according to claim 2, wherein said triangle comprises two shanks, each shank carrying a platform.

17. The device according to claim 4, wherein said platforms are movable in a direction parallel to said triangle.

18. The device according to claim 5, wherein said platforms are movable in a direction parallel to said triangle.

19. The device according to claim 4, wherein said platforms are movable in a direction perpendicular to said triangle.

20. The device according to claim 5, wherein said platforms are movable in a direction perpendicular to said triangle.
